(19) United States
(12) Patent Application Publication
(10) Pub. No.: US 2015/0356828 A1
(43) Pub. Date: Dec. 10, 2015

(54) GAMING SYSTEM AND METHOD FOR PROVIDING A SELECTION GAME WITH TEMPORARILY AVAILABLE AWARDS

(71) Applicant: IGT, Las Vegas, NV (US)

(72) Inventors: Scott A. Caputo, Santa Clara, CA (US); Brian F. Saunders, Sunnyvale, CA (US)

(21) Appl. No.: 14/665,392

(22) Filed: Mar. 23, 2015

Related U.S. Application Data
(60) Provisional application No. 62/009,528, filed on Jun. 9, 2014.

(51) Int. Cl. G07F 17/32

(52) U.S. Cl. CPC G07F 17/3262; G07F 17/3239; G07F 17/3255; G07F 17/3248; G07F 17/3246; G07F 17/3269

(57) ABSTRACT

A gaming system which displays a play of a selection game employing a plurality of awards. Each award has a value. Each award is also designated as either an available award or an unavailable award, wherein the designation of one or more of awards changes during the play of the selection game. Each award is further associated with a duration of which one, more or each of the other awards of the selection game are temporarily designated as unavailable for that player to pick. The gaming system enables a player to pick one of the awards currently designated as an available award. The gaming system provides the player the value of the picked award. The gaming system also designates one, more, or each of the remaining awards as unavailable to be picked by the player for the duration associated with the player picked award.

### PRIORITY

This application is a non-provisional of, and claims priority to and the benefit of, U.S. Patent Application No. 62/009,528, filed on Jun. 9, 2014, the entire contents of which are incorporated herein by reference.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. Gaming machines generally require the player to place or make a wager to activate the primary or base game. In many of these gaming machines, the award is based on the player obtaining a winning symbol or symbol combination and on the amount of the wager (e.g., the higher the wager, the higher the award). Generally, symbols or symbol combinations which are less likely to occur usually provide higher awards. In such known gaming machines, the amount of the wager made on the base game by the player may vary. That is, different players play at substantially different wagering amounts or levels and at substantially different rates of play.

Secondary or bonus games are also known in gaming machines. The secondary or bonus games usually provide an additional award to the player. Secondary or bonus games usually do not require an additional wager by the player to be activated. Secondary or bonus games are generally activated or triggered upon an occurrence of a designated triggering symbol or triggering symbol combination in the primary or base game. For instance, a bonus symbol occurring on the payline on the third reel of a three reel slot machine may trigger the secondary bonus game. When a secondary or bonus game is triggered, the gaming machines generally indicates this to the player through one or more visual and/or audio output devices, such as the reels, lights, speakers, video screens, etc. Part of the enjoyment and excitement of playing certain gaming machines is the occurrence or triggering of the secondary or bonus game (even before the player knows how much the bonus award will be).

Certain known gaming machines employ a variety of different selection type games as bonus games. Upon an initiation of certain of these known selection type bonus games, the gaming machine displays a plurality of selections and enables a player to pick one of the displayed selections. If the picked selection is associated with an award, the gaming machine provides the player that award. In certain selection games, the gaming machine provides the player with a limited quantity of picks (such as five picks), and enables the player to use each pick to select one of the displayed selections.

There is a continuing need to provide new, exciting, and engaging bonus games and, in particular, new, exciting, and engaging variations of selection type bonus games, to increase player enjoyment and excitement.

### SUMMARY

The present disclosure relates generally to gaming systems and methods for providing a selection game with temporarily available awards.

In various embodiments, the gaming system disclosed herein displays a play of a selection game employing a plurality of awards. Each award has a value. Each award is also designated as either an available award or an unavailable award, wherein the designation of one or more of awards changes during the play of the selection game. In addition to each award having a value and a variable available/unavailable designation, each award is further associated with a duration of which one, more, or each of the other awards of the selection game are temporarily designated as unavailable for that player to pick. In these embodiments, the gaming system enables a player to pick one of the awards currently designated as an available award. The gaming system provides the player the value of the picked award. The gaming system also designates one, more, or each of the remaining awards as unavailable to be picked by the player for the duration associated with the player picked award. That is, as a cost for the player picking an award currently deemed as available, the gaming system deems one, more, or each of the other awards of the selection game as temporarily unavailable for the player to pick. Such a configuration thus provides that a player's decision regarding which award to pick determines both the value provided to that player for the pick and the duration until the player will be enabled to make another pick of another award. Accordingly, the gaming system disclosed herein increases the level of excitement and enjoyment for certain players as these players enjoy the strategy involved in maximizing provided award values while minimizing the duration which other awards are temporarily designated as unavailable for that player to pick.

More specifically, in operation of various embodiments, upon an occurrence of a selection game triggering event, the gaming system triggers a play of a selection game. In certain embodiments, the gaming system causes a selection game triggering event to occur based on (or as a result of) one or more displayed events occurring in association with one or more plays of one or more games. In another embodiment, the gaming system causes a selection game triggering event to occur independent of any displayed events associated with any plays of any games.

For the triggered play of the selection game, the gaming system displays a plurality of awards to a player. Each award has an award value, such as a quantity of credits, a quantity of free spins, a modifier, and/or a progressive jackpot. Each award also has a variable designation as available to be picked by a player or unavailable to be picked by a player. In one embodiment, the gaming system displays each of the awards moving along a path or track wherein the awards currently positioned within a designated portion of the path are designated as available and the awards currently positioned outside of this designated portion of the path are designated as unavailable. Accordingly, at different points in time during the play of the selection game, an award may be designated as available to be picked by a player (e.g., an award currently positioned within a designated portion of the path) or unavailable to be picked by a player (an award currently positioned outside a designated portion of the path).

In addition to having a value and a current available/unavailable designation, each displayed award is associated with a duration. This duration represents a portion during the play of the selection game in which one, more, or each of the other awards are temporarily designated as unavailable for that player to pick. That is, in exchange for providing a player the value of a picked award, the gaming system causes one, more, or each of the other displayed awards to become temporarily unavailable for the player to pick. In certain embodiments, different awards having different values are associated with different durations, such that the player must weigh the value of an award against the duration, which the player would be unable to pick other awards (and thus unable to be provided the values of such other awards).

After displaying the plurality of awards, the gaming system enables the player to pick one of any awards currently designated as available for the player to pick. In the embodiment including displaying each of the awards moving along a path, the gaming system enables the player to pick any of the awards currently positioned within the designated portion of the path. It should be appreciated that since the awards of this embodiment are moving along the path (and thus the designation of one or more awards may change from available to unavailable based on such awards movement relative to the designated portion of the path), the gaming system of this embodiment provides an increased level of anticipation for certain players to pick one or more awards before such awards are deemed unavailable. It should be further appreciated since the awards of this embodiment are moving along the path (and thus the designation of one or more awards may change from unavailable to available based on such awards movement relative to the designated portion of the path), the gaming system of this embodiment further provides an element of strategy for certain players that decide to wait until one or more currently unavailable awards become available to pick.

Following the pick of an award, the gaming system provides the player the value of the picked award. The gaming system also designates one, more, or each of the remaining awards as unavailable to be picked by the player for the duration associated with the player picked award. That is, as a cost for the player picking an available award and being provided the value of that award, the gaming system temporarily deems one, more or each of the other awards of the selection game as temporarily unavailable for the player to pick. In the embodiment including displaying each of the awards moving along a path, the gaming system designates each of the awards of the path (regardless of whether or not the awards are currently positioned within or outside the designated portion of the path) as temporarily unavailable for the player to pick for a duration of time, and/or for a quantity of awards that move into and/or out of the designation portion of the path. Accordingly, by associating a fee (in regards to how long before the player may make another pick to accumulate another award) with one or more awards, the gaming system disclosed herein introduces a level of strategy that certain players enjoy.

Following the duration associated with the player picked award and thus following the designation of one, more, or each of the awards as temporarily unavailable for the player to pick, as described above, the gaming system enables the player to pick another one of any awards currently designated as available for the player to pick. This continues until a selection game termination event occurs and the play of the selection game ends.

In another embodiment, the selection game is a group game wherein one or more awards have different available/unavailable designations for different players. In one such embodiment employing displaying each of the awards moving along a path, a plurality of players are each associated with a different designated portion of the path. In this embodiment, based on the current position of an award within one player's designated portion of the path and outside of another player's designated portion of the path, the same award may be available to be picked by one player and unavailable to be picked by another player. It should be appreciated that this group selection game includes a further aspect of player strategy as one or more players weigh picking an available award versus not picking the award and running the risk that another player will pick that award.

Accordingly, the selection game disclosed herein enables different players to employ different strategies to maximize their respective awards. That is, one player may employ the strategy of picking the highest valued available awards regardless of the costs or imposed fees of such awards while another player may employ the strategy of pickings available awards with the lowest associated costs or imposed fees. As such, by providing a selection game wherein a player's decision to pick one or more awards based on the value associated with that award and the costs (in regards to when the player will be able to pick another award) associated with that award increases the level of excitement and enjoyment for certain players as these players enjoy the strategy involved in maximizing provided award values while minimizing the duration which other awards are temporarily designated as unavailable.

Additional features and advantages are described herein, and will be apparent from the following Detailed Description and the figures.

### BRIEF DESCRIPTION OF THE FIGURES

FIG. 1 is a flow chart of an example process for operating a gaming system including a selection game employing a plurality of awards as disclosed herein.

FIGS. 2A, 2B, 2C, and 2D are screen shots of one embodiment of the gaming system disclosed herein illustrating a single player selection game employing a plurality of awards.

FIG. 3 is a screen shot of one embodiment of the gaming system disclosed herein illustrating a group selection game employing a plurality of awards.

FIG. 4A is a schematic block diagram of one embodiment of a network configuration of the gaming system disclosed herein.

FIG. 4B is a schematic block diagram of one embodiment of an electronic configuration of the gaming system disclosed herein.

FIGS. 5A and 5B are perspective views of example alternative embodiments of the gaming system disclosed herein.

### DETAILED DESCRIPTION

### Selection Game with Changing Selections

In various embodiments, the gaming system disclosed herein displays a play of a selection game employing a plurality of awards. Each award has a value. Each award is also designated as either an available award or an unavailable award, wherein the designation of one or more of awards changes during the play of the selection game. In addition to each award having a value and a variable available/unavailable designation, each award is further associated with a duration of which one, more, or each of the other awards of the selection game are temporarily designated as unavailable for that player to pick. In these embodiments, the gaming system enables a player to pick one of the awards currently designated as an available award. The gaming system provides the player the value of the picked award. The gaming system also designates one, more, or each of the remaining awards as unavailable to be picked by the player for the duration associated with the player that picked award. That is, as a cost for the player picking an award currently deemed as available, the gaming system deems one, more, or each of the other awards of the selection game as temporarily unavailable for the player to pick. Such a configuration thus provides that a player's decision regarding which award to pick determines both the value provided to that player for the pick and the duration until the player will be enabled to make another pick of another award. Accordingly, the gaming system disclosed herein increases the level of excitement and enjoyment for certain players as these players enjoy the strategy involved in maximizing provided award values while minimizing the duration which other awards are temporarily designated as unavailable for that player to pick.

While certain of the embodiments described below are directed to selecting awards in a secondary game, it should be appreciated that the present disclosure may additionally or alternatively be employed in association with selecting awards in a play of a base game or primary game. Moreover, while the player's credit balance, the player's wager, and any awards are displayed as an amount of monetary credits or currency in the embodiments described below, one or more of such player's credit balance, such player's wager, and any awards provided to such player may be for non-monetary credits, promotional credits, and/or player tracking points or credits.

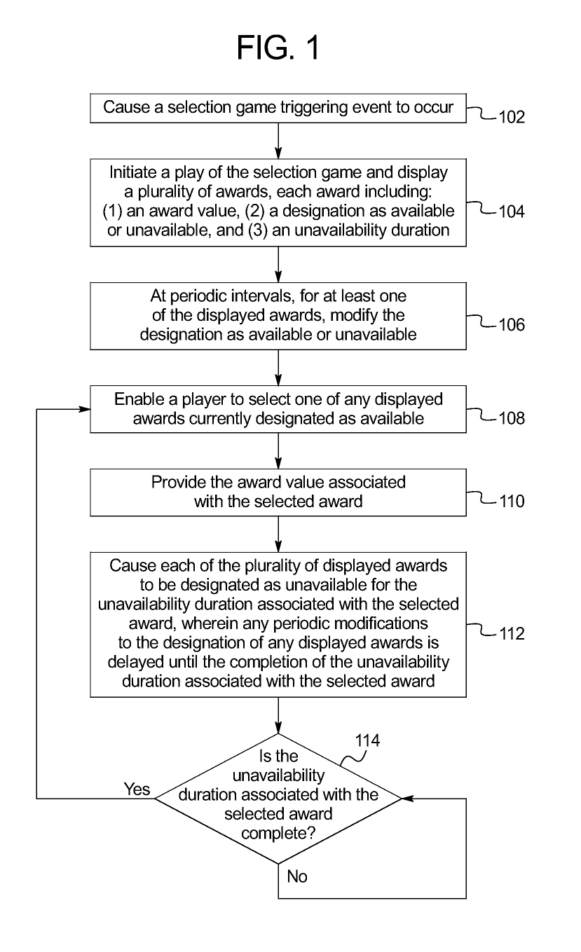

Referring now to FIG. 1, a flowchart, which illustrates an example embodiment of a process for operating a gaming system disclosed herein. In one embodiment, this process is embodied in one or more software programs stored in one or more memories and executed by one or more processors or servers. Although this process is described with reference to the flowchart illustrated in FIG. 1, it should be appreciated that many other methods of performing the acts associated with this process may be used. For example, the order of certain steps described may be changed, or certain steps described may be optional.

In this embodiment, the example is for a single player game. In this embodiment, as indicated in block 102, the gaming system causes an occurrence of a selection game triggering event.

In one embodiment, the gaming system causes a selection game triggering event to occur independent of any displayed events associated with any plays of any games. In another embodiment, the gaming system causes a selection game triggering event to occur based on (or as a result of) one or more displayed events occurring in association with one or more plays of one or more games. In another embodiment, the gaming system tracks the occurrences of one or more suitable events occurring at or in association with one or more players and/or one or more games and determines, based on these tracked events, whether a selection game triggering event occurs. In another embodiment, the gaming system defines one or more game play parameters, such as a wager amount or a maximum wager amount, wherein the gaming system determines whether a selection game triggering event occurs based on a player's tracked game play activity satisfying the defined parameter.

Upon the occurrence of the selection game triggering event, as indicated by block 104, the gaming system initiates a play of the selection game and displays a plurality of awards. Each award is associated with: (1) an award value, (2) an unavailability duration, and (3) an initial designation as available or unavailable to be picked.

In one embodiment, the award value associated each of the displayed awards is a quantity of credits. In different alternative embodiments, the award value may include a quantity of free spins, a modifier, a quantity of points, a quantity of non-monetary credits and/or a progressive award. Each award is further associated with a duration of which one, more, or each of the other awards of the selection game are temporarily designated as unavailable for that player to pick. That is, as a cost for providing a player a value of a picked award, the gaming system causes one, more, or each of the other displayed awards to become temporarily unavailable for the player to pick.

The gaming system also designates each award as either an available award or an unavailable award. That is, each award is initially designated as available to be picked by a player or unavailable to be picked by that player. In one embodiment, the initial designation is indicated by a relative location of the displayed award. In one such embodiment, the gaming system displays the plurality of awards at various positions segmented into a plurality of zones or areas. The gaming system designates at least one zone or area as the designated zone of availability, wherein any awards displayed within the designated zone of availability are designated as available for the player to pick. The gaming system further designates any displayed award outside of any designated zone of availability as unavailable for a player to pick.

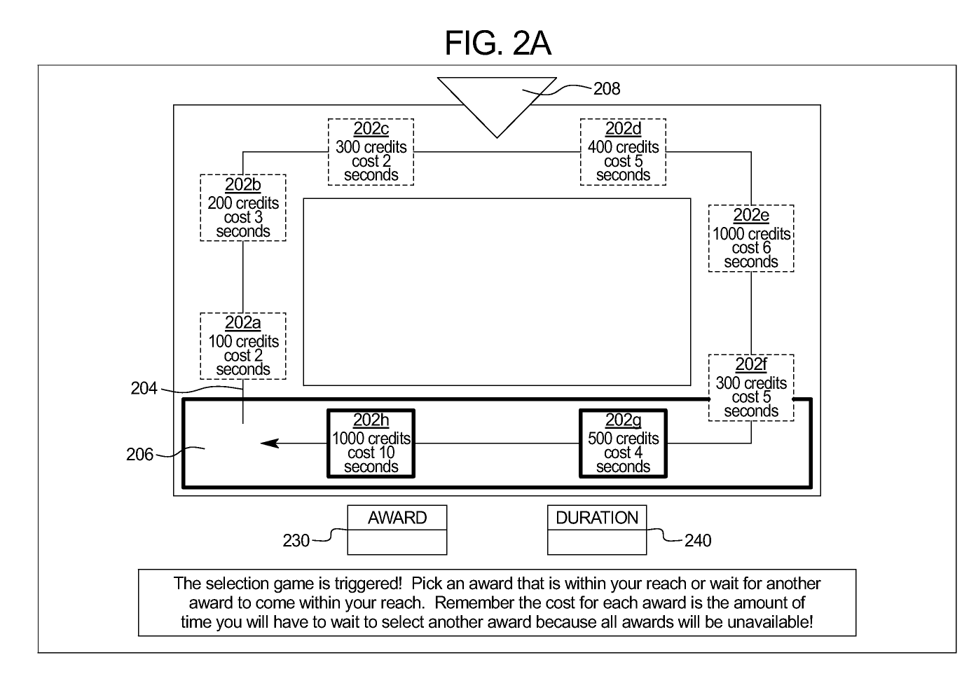

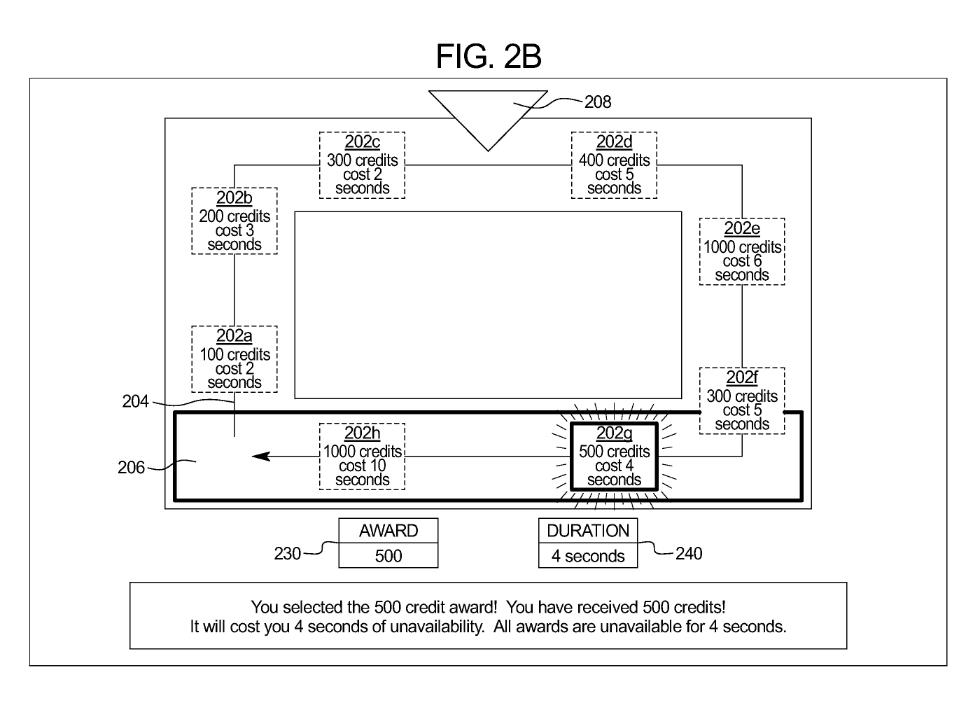

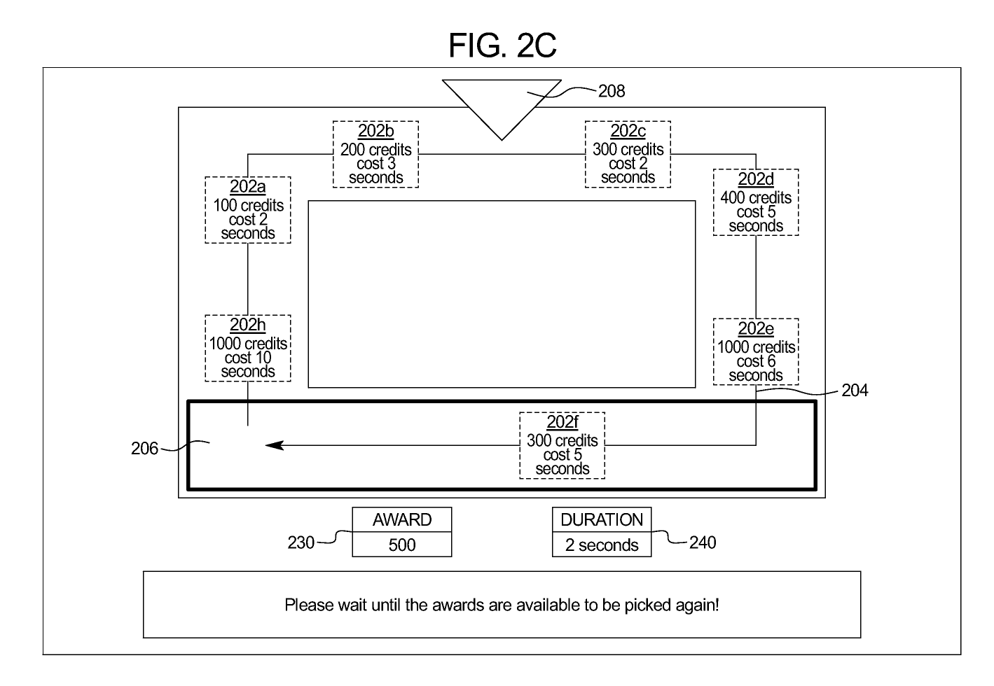

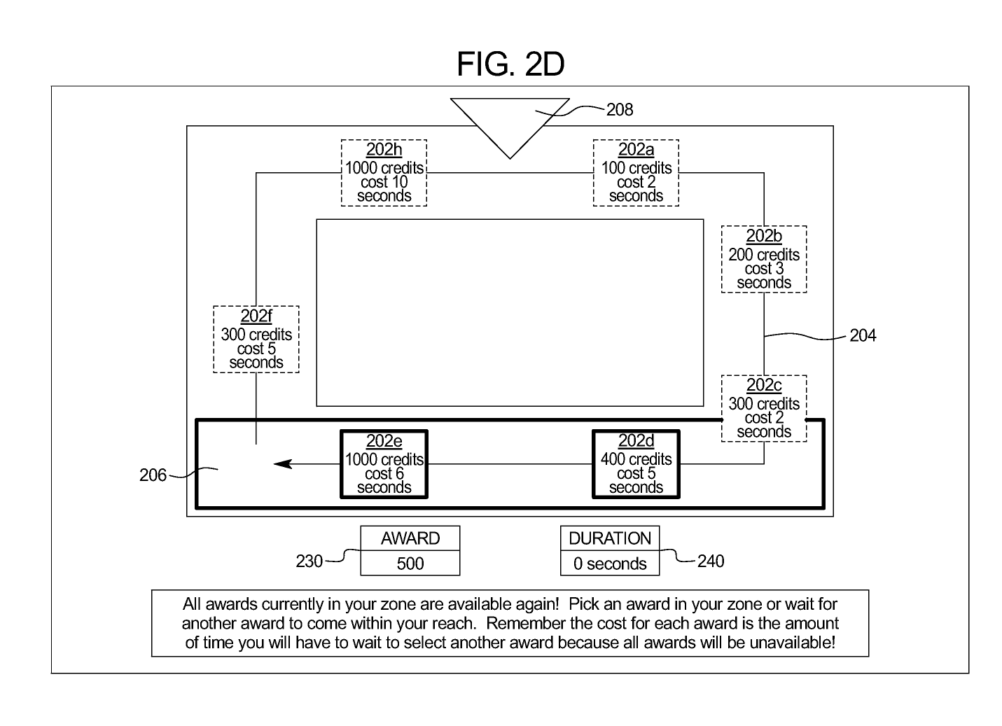

For example, as seen in FIG. 2A, the gaming system displays a plurality of awards 202a, 202b, 202c, 202d, 202e, 202f, 202g, and 202h at a plurality of positions along a track 204. Each award is associated with: (i) a displayed award value, (ii) a displayed unavailability duration (illustrated as a cost), and (iii) an initial designation as available or unavailable. In this example, the initial designation as available or unavailable is based on whether the displayed award is within the designated zone of availability 206. For example: (a) award 202a is associated with an award value of 100 credits, a cost of two seconds, and an initial designation as unavailable; (b) award 202b is associated with an award value of 200 credits, a cost of three seconds, and an initial designation as unavailable; (c) award 202c is associated with an award value of 300 credits, a cost of two seconds, and an initial designation as unavailable; (d) award 202d is associated with an award value of 400 credits, a cost of five seconds, and an initial designation as unavailable; (e) award 202e is associated with an award value of 1000 credits, a cost of six seconds, and an initial designation as unavailable; (f) award 202f is associated with an award value of 300 credits, a cost of four seconds, and an initial designation as unavailable (award 202f is not entirely within the shaded region 206); (g) award 202g is associated with an award value of 500 credits, a cost of four seconds, and an initial designation as available (award 202g is within the shaded region 206); and (h) award 202h is associated with an award value of 1000 credits, a cost of ten seconds, and an initial designation as available (award 202h is within the shaded region 206).

In addition to displaying the plurality of awards, as indicated in block 106 of FIG. 1, at periodic intervals, the gaming system modifies the designation of at least one of the displayed award as available or unavailable.

For example, as illustrated in FIG. 2A, the gaming system moves the displayed awards 202 along a track 204 in a clockwise direction. In this embodiment, the gaming system modifies the designation by moving the displayed awards into and out of the designated zone of availability 206. Accordingly, at different points in time during the play of the selection game, the gaming system designates an award as available to be picked by a player (e.g., an award currently positioned within a designated zone of the path) or unavailable to be picked by a player (an award currently positioned outside of a designated zone of the path). For example, in FIG. 2A, the gaming system designates the displayed awards 202h and 202g as available because the awards are within the shaded portion 206 of the track 204. In this embodiment, the gaming system displays the available awards with a solid line. The gaming system designates the remaining awards as unavailable, as further indicated by the dotted lines. As the gaming system moves the displayed awards along the track or path, the gaming system periodically moves at least one of the displayed awards into or out of the designated zone of availability 206 thereby modifying the designation associated with the displayed award as available or unavailable.

In addition to periodically modifying the designation of the displayed awards as available and unavailable, as indicated in block 108 of FIG. 1, the gaming system enables the player to select one of any displayed award currently designated as available.

For example, as illustrated in FIG. 2A, the gaming system displays two awards in the designated zone of availability, award 202g and award 202h. The gaming system enables the player to select either of the two awards designated as available. Award 202g is associated with an award value of 500 credits and an unavailability duration of four seconds, and award 202h is associated with an award value of 1000 credits and an unavailability duration of ten seconds.

As further illustrated in FIG. 2B, there is another 1000 credit award 202e approaching the shaded portion 206. Thus, it may be advantageous for the player to choose an award associated with a lower unavailability duration so that the player may be able to select both the 500 credit award 202g and the approaching 1000 credit award 202e. That is, there is strategy involved in maximizing provided award values while minimizing the duration which other awards are temporarily designated as unavailable for that player to pick. In this example, the gaming system provides appropriate messages such as “THE SELECTION GAME IS TRIGGERED! PICK AN AWARD THAT IS WITHIN YOUR REACH OR WAIT FOR ANOTHER AWARD TO COME WITHIN YOUR REACH! REMEMBER THE COST FOR EACH AWARD IS THE AMOUNT OF TIME YOU WILL HAVE TO WAIT TO SELECT ANOTHER AWARD BECAUSE ALL AWARDS WILL BE UNAVAILABLE!” to the player visually, or through suitable audio or audiovisual displays.

Once the player selects an available displayed award, as indicated in block 110 of FIG. 1, the gaming system provides the award value associated with the selected award.

For example, as illustrated in FIG. 2B, the player selects award 202g associated with an award value of 500 credits and an unavailability duration of four seconds. The gaming system provides the player the award value of 500 credits as shown in the award display 230.

In addition to providing the award value associated with the selected award, as indicated in block 112, the gaming system causes each of the plurality of displayed awards to be associated with a duration of which one, more, or each of the other awards of the selection game are temporarily designated as unavailable for that player to pick. That is, during the unavailability duration, the gaming system continues to move the displayed awards, however the gaming system does not modify the designation of any displayed awards as available or unavailable. Instead, during the unavailability duration, in this embodiment, the gaming system designates each of the displayed awards, including those within the designated zone of availability, to be unavailable for the player to select. The gaming system delays any periodic modifications to the designation of any displayed awards until after the completion of the unavailability duration associated with the selected award.

For example, as illustrated in FIG. 2B, the gaming system displays an unavailability duration display 240 which indicates that “4 seconds” remain for the unavailability duration. The gaming system displays all unselected awards with a dotted line indicating that all unselected awards are currently unavailable for the player to pick. Award 202h, which is within the shaded portion 206 of the track 204, is also unavailable for the player to pick during the unavailability duration.

Turning to FIG. 2C, as illustrated in FIG. 2C, the gaming system displays “2 seconds” remain for the unavailability duration as indicated in 240. The gaming system continues to move the displayed awards, as indicated by the different positions of the award displays in FIG. 2C from FIG. 2B. The gaming system moved award 202h outside of the shaded portion 206 of the track 204. The gaming system moved award 202f, which was previously outside of the shaded portion 206 of the track 204, into the shaded portion 206 of the track 204. The gaming system displays the both awards with a dotted line indicating that both are still unavailable for the player to pick. In this example, the gaming system provides appropriate messages such as “PLEASE WAIT UNTIL THE AWARDS ARE AVAILABLE TO BE PICKED AGAIN!” to the player visually, or through suitable audio or audiovisual displays.

As indicated by diamond 114 of FIG. 1, after causing each of the plurality of awards to be designated as unavailable, the gaming system determines whether the unavailability duration associated with the selected award is complete. If the gaming system determines that the unavailability duration associated with the selected award is not complete, the gaming system continues to check whether the unavailability duration is completed. On the other hand, if the unavailability duration associated with the selected award is complete, the gaming system returns to block 108 and enables the player to select another displayed award currently designated as available. Because the unavailability duration is complete, the gaming system resumes periodically modifying the designation as available or unavailable for any displayed awards that move into or out of a designated zone of availability.

For example, as illustrated in FIG. 2D, the duration display indicates that “0 seconds” remain for the unavailability duration, thus the unavailability duration is complete. The gaming system continues to move the displayed awards as indicated by the different positions of the awards in FIG. 2D from FIG. 2C. Awards 202d and 202e are within the shaded portion 206 and are designated as available as further indicated by the solid lines around the award. In this example, the gaming system provides appropriate messages such as “ALL AWARDS CURRENTLY IN YOUR ZONE ARE AVAILABLE AGAIN! PICK AN AWARD IN YOUR ZONE OR WAIT FOR ANOTHER AWARD TO COME WITHIN YOUR REACH. REMEMBER THE COST FOR EACH AWARD IS THE AMOUNT OF TIME YOU WILL HAVE TO WAIT TO SELECT ANOTHER AWARD BECAUSE ALL AWARDS WILL BE UNAVAILABLE!” to the player visually, or through suitable audio or audiovisual displays.

In various embodiments, at any time during the play of the selection game, if a selection game termination event occurs, the gaming system terminates the play of the game. In one such embodiment, the selection game termination event randomly occurs. In certain alternative embodiments, the selection game termination event occurs after a predetermined duration, such as a period of time, after a quantity of awards that have been selected, or after a quantity of rounds that a displayed award moves. In other embodiments, the selection game termination event is based on a predetermined quantity of selections made by the player. In another embodiment, the selection game termination event is based on the player selecting a designated award or a quantity of designated awards.

In another alternative embodiment, the gaming system provides the player a quantity of credits at the start of the selection game. In one such embodiment, the gaming system enables the player to use the provided credits to purchase each displayed award, each displayed award is associated with a purchase credit value, wherein for each selected award, the gaming system reduces the total initial provided credits by the purchase credit value associated with the selected award. In this embodiment, the selection game termination event occurs when the player uses all of the provided credits.

It should be appreciated that the example embodiment described with respect to FIGS. 1 and 2A to 2D is an individual player embodiment. In another embodiment, the selection game is a community selection game. In this embodiment, each of a plurality of players playing a plurality of electronic gaming machines participate in the play of the selection game by selecting displayed awards of the selection game. In one embodiment, the selection game is a cooperative community game wherein a plurality of players cooperate or play together to select the displayed awards of the selection game. In another embodiment, the selection game is a competition community game wherein a plurality of players compete or play against each other to select more awards or awards associated with higher award values than other players of the selection game.

In one embodiment, wherein the selection game is a community game with a plurality of players, the gaming system displays a plurality of awards and each award is associated with: (i) an award value, (ii) an unavailability duration, and (iii) a designation as available and unavailable.

In one such embodiment, the gaming system provides a different designated zone of availability for each player. For each zone, the gaming system designates any award that the gaming system displays within that zone as available for the player associated with that zone. In this embodiment, based on the current position of an award, the gaming system may designate the same award as available to pick for one player, and unavailable to pick for another player at the same time. That is, the gaming system may display an award within one player's zone, (i.e., designated zone of availability along the path) and outside of another player's zone (i.e., designated zone of availability along the path), thereby enabling one player to select the award which another player cannot. It should be appreciated that in this embodiment, the gaming system enables the plurality of players to select from the same pool of awards and thus, this group selection game includes a further aspect of player strategy as one or more players weigh picking an available award versus not picking the award and running the risk that another player will pick that award.

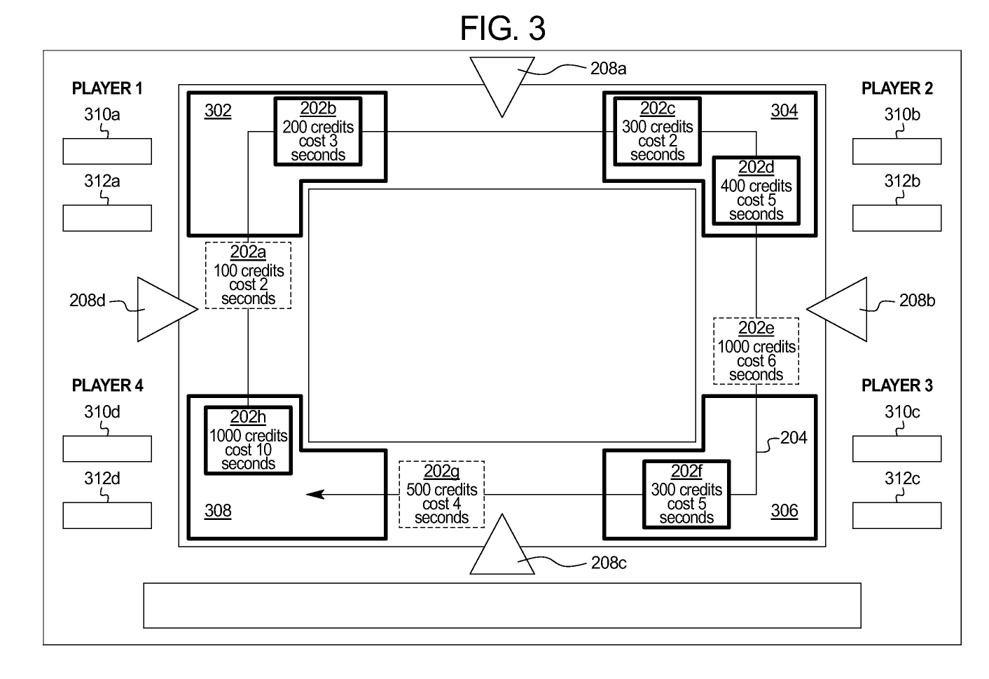

For example, as illustrated in FIG. 3, the gaming system displays a selection game for four different players. For each player, the gaming system provides a separate shaded zone 302, 304, 306 and 308. For each player, the gaming system designates any awards within the player's zone as available. For example the gaming system designates: (a) award 202a as unavailable for all players; (b) award 202b as available for Player 1 and as unavailable for all other players; (c) award 202c as available for Player 2 and as unavailable for all other players; (d) award 202d as available for Player 2 and unavailable for all other players; (e) award 202e as unavailable for all players; (f) award 202f as available for Player 3 and unavailable for all other players; (g) award 202g as unavailable for all players; (h) award 202h as available for Player 4 and unavailable for all other players. In this embodiment, the gaming system displays available awards with a solid line and unavailable awards with a dotted line.

In a group selection game, when a player picks an available award, the unavailability duration associated with the displayed award applies to that player. That is, if a first player selects an award associated with a first award value and a first unavailability duration, the gaming system provides the player the first award (i.e., the award value associated with picked award) and one, more or each of the other awards are unavailable for the first player for the first unavailability duration.

As further illustrated in FIG. 3, the gaming system provides a separate award display 310a, 310b, 310c, and 310d and a separate unavailability duration display 312a, 312b, 312c, and 312d for each player.

In certain embodiments, the gaming system provides an additional award for the player who consumes the most awards or the highest award value or the award with the highest unavailability duration.

### Selection Game Triggering Event

In different embodiments, a selection game triggering event occurs based on an outcome associated with one or more plays of any primary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game causes such conditions to be satisfied and/or one or more of such events to occur.

In different embodiments, the gaming system does not provide any apparent reasons to the players for an occurrence of a selection game triggering event. In these embodiments, such determinations are not triggered by an event in a primary game or based specifically on any of the plays of any primary games. That is, these events occur without any explanation or alternatively with simple explanations.

In one such embodiment, selection game triggering event occurs based on an amount of coin-in. In this embodiment, the gaming system determines if an amount of coin-in reaches or exceeds a designated amount of coin-in (i.e., a threshold coin-in amount). Upon the amount of coin-in wagered reaching or exceeding the threshold coin-in amount, the gaming system causes one or more of such events or conditions to occur. In another such embodiment, a selection game triggering event occurs based on an amount of virtual currency-in. In this embodiment, the gaming system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the gaming system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a selection game triggering event occurs based on an amount of coin-out. In this embodiment, the gaming system determines if an amount of coin-out reaches or exceeds a designated amount of coin-out (i.e., a threshold coin-out amount). Upon the amount of coin-out reaching or exceeding the threshold coin-out amount, the gaming system causes the selection game triggering event to occur. In another such embodiment, selection game triggering event occurs based on an amount of virtual currency-out. In this embodiment, the gaming system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the gaming system causes the selection game triggering event to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a selection game triggering event occurs based on a predefined variable reaching a defined parameter threshold. For example, when the 500,000^{th} player has played an electronic gaming machine (ascertained from a player tracking system), the selection game triggering event occurs. In different embodiments, the predefined parameter thresholds include a length of time, a length of time after a certain dollar amount is hit, a wager level threshold for a specific device (which electronic gaming machine is the first to contribute $250,000), a number of electronic gaming machines active, or any other parameter that defines a suitable threshold.

In different embodiments, a selection game triggering event occurs based on a quantity of games played. In this embodiment, a quantity of games played is set for when the selection game triggering event will occur. In one embodiment, such a set quantity of games played is based on historic data.

In different embodiments, selection game triggering event occurs based on time. In this embodiment, a time is set for when one or more of such events or conditions will occur. In one embodiment, such a set time is based on historic data.

In different embodiments, a selection game triggering event occurs based upon gaming system operator defined player eligibility parameters stored on a player tracking system (such as via player tracking card or other suitable manner). In this embodiment, the parameters for eligibility are defined by the gaming system operator based on any suitable criterion. In one embodiment, the gaming system recognizes the player's identification (via the player tracking system) when the player inserts or otherwise associates their player tracking card in the electronic gaming machine. The gaming system determines the player tracking level of the player and if the current player tracking level defined by the gaming system operator is eligible for one or more of such events or conditions. In one embodiment, the gaming system operator defines minimum bet levels required for such events or conditions to occur based on the player's card level.

In different embodiments, a selection game triggering event occurs based on a system determination, including one or more random selections by the central controller. In one embodiment, as described above, the gaming system tracks all active electronic gaming machines and the wagers they placed. In one such embodiment, based on the electronic gaming machine's state as well as one or more wager pools associated with the electronic gaming machine, the gaming system determines whether selection game triggering event will occur. In one such embodiment, the player who consistently places a higher wager is more likely to be associated with an occurrence the selection game triggering event than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, selection game triggering event occurs based on a determination of if any numbers allotted to an electronic gaming machine match a randomly selected number. In this embodiment, upon or prior to each play of each electronic gaming machine, an electronic gaming machine selects a random number from a range of numbers and during each primary game, the electronic gaming machine allocates the first N numbers in the range, where N is the number of credits bet by the player in that primary game. At the end of the primary game, the randomly selected number is compared with the numbers allocated to the player and if a match occurs, one or more of such events or conditions occur. It should be appreciated that any suitable manner of causing a selection game triggering event to occur may be implemented in accordance with the gaming system and method disclosed herein.

It should be appreciated that one or more of the above-described triggers pertaining to one or more of such triggering events occurring may be combined in one or more different embodiments.

### Displayed Awards

In certain embodiments of the present disclosure, the gaming system displays a same set of awards for the entire play of the selection game. In certain alternative embodiments, the gaming system introduces new, different awards throughout the play of the selection game. In one such embodiment, the gaming system removes any unselected displayed awards after a duration. That is, each displayed award is temporarily provided in the selection game.

In certain embodiments, the duration that the gaming system displays an award includes a period of time, a quantity of selections, or a quantity of rounds completed by the displayed award. For example, in one embodiment, after the gaming system moves the displayed awards a designated distance (i.e., such as around the track 204 in FIGS. 2A to 2D), the gaming system removes the displayed award from the play of the game.

Referring back to FIGS. 2A to 2D, in certain embodiments, the gaming system includes an entrance and/or exit as illustrated in FIGS. 2A to 2D by 208. In one embodiment, the awards input to the track are input through this entrance and any awards removed from the track are removed from this exit. In certain embodiments, the gaming system includes multiple entrance and exit areas. In certain embodiments, the gaming system displays the award in a preview area outside of the entrance before it enters the track. That is, the gaming system enables the player to preview the next award to be input to the track. In other embodiments, the upcoming award is unknown to the player.

In one embodiment, as the selection game progresses, the gaming system displays new awards associated with higher award values than at the start of the selection game. In certain alternative embodiments, the gaming system provides displayed awards associated with a higher award value at the start of the selection game and provides awards associated with lower award values as the selection game progresses. In other alternative embodiments, the gaming system provides a variety of high and low award values throughout the selection game. In various alternative embodiments, the gaming system provides a certain jackpot value after a predetermined duration of the selection game. Similarly, in certain embodiments, the gaming system provides displayed awards associated with higher unavailability durations as the selection game progresses. In other embodiments, the gaming system provides displayed awards associated with lower unavailability durations as the selection game progresses. In other embodiments, the gaming system varies the unavailability duration associated with the displayed awards throughout the selection game.

In certain embodiments, the gaming system displays all of the awards available during the selection game. In certain alternative embodiments, the gaming system displays a subset of the awards. In one embodiment, the gaming system displays the awards within the designated zone of availability. In certain alternative embodiments, the gaming system randomly determines which awards to display to the player such that awards randomly appear and disappear throughout the selection game.

In various embodiments of the present disclosure, the gaming system alters the rate of movement of the displayed awards. In one embodiment, the selection game display includes a grid of evenly spaced positions and the gaming system moves each displayed award from one position to the next at a predetermined rate. For example, the gaming system moves each displayed award at a rate of one position per second. In this example, the player can predict the location of each displayed award over a designated duration. In other embodiments, the gaming system moves the displayed awards at a variable rate. That is, the gaming system speeds up and slows down the rate of movement for the displayed awards to increase the difficulty of a player predicting the location of each displayed award over a designated duration. In certain embodiments, the gaming system randomly changes the rate of movement. In certain embodiments, the gaming system changes the rate of movement at a predetermined interval or after a predetermined duration. In certain embodiments of the present disclosure, the gaming system changes the rate of movement based on certain displayed events. In one example, the gaming system increases or decreases the rate of movement based on the player selected a designated award. In another example the gaming system increases or decreases the rate of movement based on the player selecting a designated quantity of awards. It should be appreciated that the rate of movement of the displayed awards impacts the duration that each award will remain with a designated zone of availability.

### Award Value and Unavailability Duration

In various embodiments of the present disclosure, the gaming system provides various different types of award values associated with each displayed award. In the example embodiment described above with respect to FIGS. 2A to 2D, each of the displayed awards are associated with a credit value. In certain alternative embodiments, the displayed awards are associated with a quantity of free spins, a modifier value, or a progressive award. In certain alternative embodiments, the gaming system includes a plurality of different types of award values associated with each award for a play of the selection game. In other alternative embodiments, the gaming system enables the player to request a specific type of award value to be associated with the displayed awards. In a different alternative embodiment, the gaming system enables the player to request a type of award if the player selects a designated type of award or a designated quantity of awards within a designated duration.

In certain embodiments, the award value associated with an award impacts other aspects of the game. For example, in one embodiment, if the player selects a designated award, the gaming system delays the selection game termination event. In one such embodiment, the award value associated with a designated award is additional time for the selection game. In certain alternative embodiments, the gaming system delays the selection game termination event if the player selects a designated quantity of awards or a designated quantity of a designated type of award. That is, in one example, the gaming system provides a bonus duration of the selection game if the player selects a designated award, a designated quantity of awards, and/or a designated total award value, within a predetermined time. In another example, the gaming system speeds up the onset of a selection game termination event based on the selection of a designated award. For example, in one embodiment, if a player selects a designated award, the gaming system reduces the time remaining in the selection game. In another example, the selection of a designated award triggers a selection game termination event.

In the embodiment described above with respect to FIGS. 2A to 2D, the gaming system maintains the same award value associated with each displayed award while the gaming system moves the displayed award during the play of the game. In certain alternative embodiments, the award value associated with each displayed award is dynamic. That is, the gaming system changes the award value of the displayed award as the gaming system moves the displayed award during the play of the game. In one example, the gaming system increases the award value as the gaming system moves the displayed award during the play of the game. In another example, the gaming system decreases the award value as the gaming system moves the displayed award during the play of the game.

In various embodiments of the present disclosure, the displayed awards are associated with a plurality of different types of unavailability durations. In the example embodiment described above with respect to FIGS. 2A to 2D, the unavailability duration represents the period of time that one, more or each of the other displayed awards is available to be picked. In certain alternative embodiments, the duration is a quantity of other awards that the gaming system moves by the player's designated zone of availability before the gaming system designates any awards as available again. For example, an unavailability duration associated with a selected award is three unselected awards pass the player's designated zone of availability. In this example, the player selects an award, and must let the next three awards move past the designated zone of availability before the gaming system enables the player to select another award within the designated zone of availability.

In one alternative embodiment, the gaming system does not associate an unavailability duration with a displayed award. In one example of this embodiment, once a selection game triggering event occurs, the gaming system provides the player a quantity of total credits. For example, the gaming system provides the player 20 credits. Each of the displayed awards are associated with a different quantity of credits. For example, a plurality of displayed awards are associated with a cost of 5 credits, and another plurality of displayed awards are associated with a cost of 1 credit. In this example, the gaming system enables the player to select as many awards as possible until the player has depleted all of the 20 total credits. In this example, the gaming system displays the award value associated with each displayed award so the player knows the award value of each displayed award. In another variation of this embodiment, the gaming system does not display the award value associated with each displayed award. That is, while each displayed award may cost a certain credit amount, the award value associated with each displayed award may not match the cost.

In various embodiments of the present disclosure, the unavailability duration associated with each displayed award remains the same as the game progresses. In certain alternative embodiments, the unavailability duration associated with each award is dynamic. That is, the unavailability duration associated with the displayed award changes as the game progresses. In one such embodiment, wherein the displayed awards move during the play of the game, the unavailability duration associated with the displayed awards change as the displayed award move. For example, the unavailability duration associated with each displayed award increases as the displayed award progresses. In an alternative embodiment, the unavailability duration decreases as the displayed award progresses. In certain embodiments, the unavailability duration associated with each displayed award changes if the player selects a designated award, a designated quantity of awards, and/or reaches a designated award value.

It should be appreciated that in the example embodiments described above with respect to FIGS. 2A to 2D, the award value and unavailability duration associated with each displayed award is displayed. In other alternative embodiments, the award value and/or the unavailability duration associated with the displayed award is unknown. That is, the gaming system does not display the award value and/or the unavailability duration associated with a displayed award until after the player selects the displayed award. For example, in one embodiment, the award value associated with each displayed award is unknown, but the unavailability duration associated with each displayed award is known. In another alternative embodiment, the unavailability duration associated with each displayed award is unknown, but the award value associated with each displayed award is known.

In certain alternative embodiments, the gaming system displays a representation of the award value and/or unavailability duration associated with each award without displaying the actual award value or unavailability duration. In one embodiment, the award value and/or unavailability duration associated with each award is represented by a different attribute such as a color. In one example, each displayed award is associated with one of a plurality of different colors and associates each color with a different amount of award value and/or unavailability duration. That is, in this example all awards associated with the color red are associated with an award value of 100 credits and/or a unavailability duration of 5 seconds, and all awards associated with the color blue are associated with an award value of 500 credits and/or a unavailability duration of 10 seconds. In another embodiment, the color associated with each displayed award represents a type of award value and/or unavailability duration. For example, with respect to award values: (1) the color red represents a credit value, (2) the color blue represents free spins, and (3) the color yellow represents a modifier. In another example, with respect to unavailability duration: (1) the color red represents a period of time of unavailability, and (2) the color blue represents a quantity of awards that must pass before the period of unavailability is over.

In another alternative embodiment the gaming system displays the relative award value and/or unavailability duration associated with each displayed award by the size of the image associated with displayed award. For example, if the displayed award is displayed as a plate of food, the bigger the pile of food on the plate, the bigger the award (and/or unavailability duration) associated with the award.

### Designation as Available or Unavailable

In certain embodiments, as described above, the gaming system designates a displayed award as available or unavailable based on the relative location of the displayed award. More specifically, the gaming system designates at least one zone or area of availability and designates awards within that zone as available and awards outside of that zone as unavailable. In certain embodiments, the gaming system changes the designated zone of availability based on certain displayed events during the play of the game. In one such embodiment, the gaming system increases a designated zone of availability if the player selects a designated award, a designated quantity of awards, and/or reaches a designated award value. In another embodiment, the gaming system decreases the designated zone of availability if the player selects a designated award, a designated quantity of awards, and/or reaches a designated award value. In certain embodiments, the change in the designated zone of availability is for a limited duration. In other embodiments, the change in the designated zone of availability is for the remainder of the selection game.

In certain embodiments, the gaming system designates a displayed award as available if the award is entirely within the designated zone of availability. That is, the gaming system designates any award partially within the designated zone of availability as unavailable. In certain alternative embodiments, the gaming system designates as available any displayed award partially within the designated zone of availability.

In certain alternative embodiments, the gaming system designates the displayed awards as available or unavailable based on an attribute associated with the displayed award. For example, each displayed award is associated with one of a plurality of colors, and the awards associated with a certain designated color are available for a player to pick. In another example, the gaming system displays each unavailable award as a faded award and all available awards in bold.

As described above, the gaming system modifies the designation as available or unavailable at periodic intervals. In certain embodiments the periodic intervals include duration of time. For example, the gaming system modifies the availability designation of at least one displayed award every 10 seconds. In other embodiments, the periodic intervals include an event in the play of the game. For example, the gaming system modifies the availability designation of the at least one displayed award when it is in a certain position.

In the embodiments described above with respect to FIGS. 2A to 2D, the gaming system modifies the availability designation of each award by moving each award into and out of a zone of availability. In certain alternative embodiments, the movement of the displayed awards may be stopped or delayed by various blockers. For example, a blocker may stop the movement of all displayed awards for a duration. In another example, a blocker may appear along the track and for a duration stop any movement beyond the blocker of any displayed awards behind the blocker. That is, if a blocker appears along the track, the gaming system continues to move all displayed awards behind the blocker up to the blocker, wherein the awards begin to pile up near the blocker. In some embodiments, the gaming system displays a blocker if the player selects a designated award, a designated quantity of awards and/or reaches a designated award value.

In certain embodiments, the gaming system provides the player a blocker such that the player can choose where and/or when to use the blocker. In certain embodiments, the gaming system enables the player to buy or earn one or more blockers for a play of the selection game. It should be appreciated, that in a group game embodiment, a blocker would provide a player an advantage over other players.

### Alternative Embodiments

In one embodiment, the gaming system causes at least one display device of at least one electronic gaming machine to display the selection game. In one such embodiment, the gaming system causes a supplemental display device, such as a top box, of an electronic gaming machine to display the selection game. In another such embodiment, the gaming system causes the selection game to be displayed in one or more service windows or pop-up screens. In another embodiment, in addition or in alternative to each electronic gaming machine displaying the selection game, one or more players, the gaming system causes one or more community or overhead display devices to display part or all of the selection game to one or more other players or bystanders either at a gaming establishment or viewing over a network, such as the internet. In another embodiment, in addition or in alternative to each electronic gaming machine displaying the selection game, the gaming system causes one or more internet sites to each display the selection game such that a player is enabled to log on from a personal web browser. In another such embodiment, the gaming system enables the player to play one or more games on one device while viewing the selection game from another device, such as a desktop or laptop computer.

In one embodiment, the selection game is a persistent or ongoing game. In this embodiment, following the occurrence of a selection game triggering event, such as an initiation of a gaming session, the gaming system continuously displays the selection game over one or more plays of one or more primary games. That is, following an occurrence of a selection game triggering event, the gaming system displays the selection game persisting from one play of a primary game to another play of the primary game. It should thus be appreciated that in this embodiment, prior to one or more players initiating any plays of any games, the gaming system displays the selection game to such players.

In one embodiment, the selection game is personal to the player playing the selection game. In this embodiment, if the player leaves the electronic gaming machine, the gaming system stores the current state of the player's personal selection game, wherein when the player later returns to an electronic gaming machine, the gaming system recalls the stored state of the player's personal selection game.

In one embodiment, the selection game is associated with a plurality of different levels. In one such embodiment, after a player has satisfied one or more criteria associated with one level (e.g., the player has selected a designated quantity or designated type of displayed award of the selection game), the gaming system progresses to the next level of the selection game. In this embodiment, each progressive level of the selection game is associated with increasing selection game awards.

In different embodiments, one or more awards provided in association with one or more primary game plays, one or more secondary game plays, and/or one or more community game plays include one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product such as a free teddy bear, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), virtual goods associated with the gaming system, virtual goods not associated with the gaming system, an access code usable to unlock content on an internet.

It should be appreciated that in different embodiments, one or more of:
i. whether a selection game triggering event occurs;
ii. when the selection game triggering event occurs;
iii. which awards to display;
iv. a quantity of awards to display;
v. where in the selection game display to display each award;
vi. what type of award value to associate with each award;
vii. what award value to associate with each award;
viii. whether the award value associated with each award should change;
ix. when to modify the award value associated with each award;
x. whether to remove a displayed award from a play of the selection game;
xi. when to remove a displayed award from a play of the selection game;
xii. what type of unavailability duration to associated with each award;
xiii. what unavailability duration to associate with each award;
xiv. whether the associated unavailability duration with each award should change;
xv. when to change the unavailability duration associated with each award;
xvi. which awards to designate as available;
xvii. when to modify the availability designation of each award;
xviii. what is the periodic interval for modification of the availability designation;
xix. where to display the designated zone of availability associated with each player;
xx. how many areas to determine to be the designated zone of availability associated with each player;
xxi. what size to make the designated zone of availability associated with each player;
xxii. what the rate of movement should be for the displayed awards;
xxiii. whether to change the rate of movement of the displayed awards;
xxiv. how much to change the rate of movement;
xxv. whether to provide any blockers;
xxvi. how many blockers to provide;
xxvii. when to provide any blockers;
xxviii. whether a selection game termination event occurs;
xxix. what the selection game termination event is;
xxx. when the selection game termination event occurs; and/or
xxxi. any determination disclosed herein;
   is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming system, determined independent of a random determination at the gaming system, determined based on at least one play of at least one game, determined independent of at least one play of at least one game, determined based on a player's selection or input, determined independent of a player's selection or input, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (i.e., a player tracking status), determined independent of a status of the player (i.e., a player tracking status), determined based on one or more other determinations disclosed herein, determined independent of any other determination disclosed herein or determined based on any other suitable method or criteria.

### Gaming Systems

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more electronic gaming machines (“EGMs”); and/or (c) one or more personal gaming devices, such as desktop computers, laptop computers, tablet computers or computing devices, personal digital assistants (PDAs), mobile telephones such as smart phones, and other mobile computing devices.

Thus, in various embodiments, the gaming system of the present disclosure includes: (a) one or more EGMs in combination with one or more central servers, central controllers, or remote hosts; (b) one or more personal gaming devices in combination with one or more central servers, central controllers, or remote hosts; (c) one or more personal gaming devices in combination with one or more EGMs; (d) one or more personal gaming devices, one or more EGMs, and one or more central servers, central controllers, or remote hosts in combination with one another; (e) a single EGM; (f) a plurality of EGMs in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each EGM and each personal gaming device of the present disclosure is collectively referred herein as an “EGM.” Additionally, for brevity and clarity, unless specifically stated otherwise, “EGM” as used herein represents one EGM or a plurality of EGMs, and “central server, central controller, or remote host” as used herein represents one central server, central controller, or remote host or a plurality of central servers, central controllers, or remote hosts.

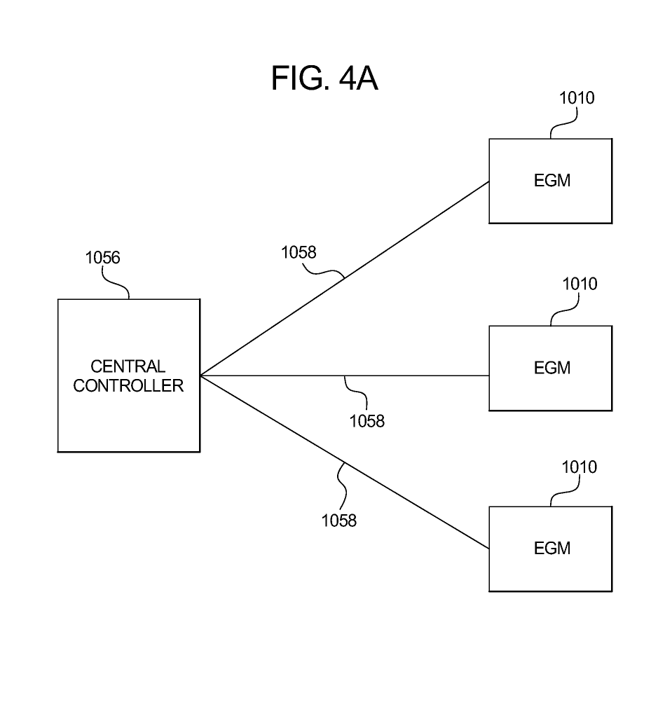

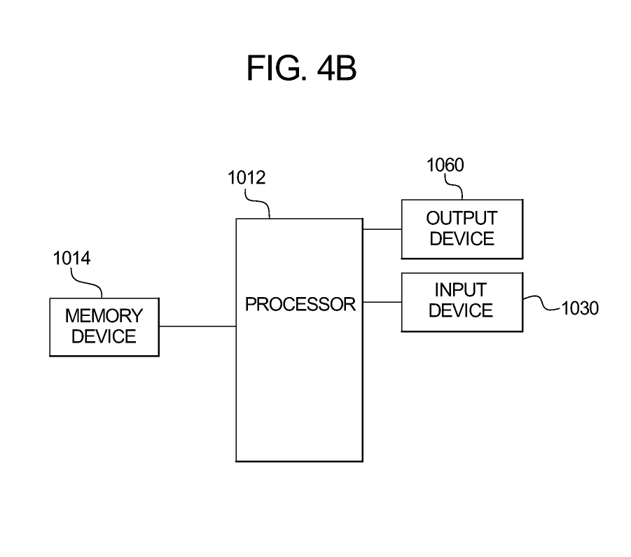

As noted above, in various embodiments, the gaming system includes an EGM in combination with a central server, central controller, or remote host. In such embodiments, the EGM is configured to communicate with the central server, central controller, or remote host through a data network or remote communication link. In certain such embodiments, the EGM is configured to communicate with another EGM through the same data network or remote communication link or through a different data network or remote communication link. For example, the gaming system illustrated in FIG. 4A includes a plurality of EGMs 1010 that are each configured to communicate with a central server, central controller, or remote host 1056 through a data network 1058.

In certain embodiments in which the gaming system includes an EGM in combination with a central server, central controller, or remote host, the central server, central controller, or remote host is any suitable computing device (such as a server) that includes at least one processor and at least one memory device or storage device. As further described herein, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the EGM. It should be further appreciated that one, more, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes: (a) an EGM configured to communicate with a central server, central controller, or remote host through a data network; and/or (b) a plurality of EGMs configured to communicate with one another through a data network, the data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: (a) an EGM configured to communicate with a central server, central controller, or remote host through a data network; and/or (b) a plurality of EGMs configured to communicate with one another through a data network, the data network is a wide area network (WAN) in which one or more of the EGMs are not necessarily located substantially proximate to another one of the EGMs and/or the central server, central controller, or remote host. For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server, central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central server, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

### EGM Components

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs). FIG. 4B illustrates an example EGM including a processor 1012.

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). The example EGM illustrated in FIG. 4B includes a memory device 1014. It should be appreciated that any other suitable magnetic, optical, and/or semiconductor memory may operate in conjunction with the EGM disclosed herein. In certain embodiments, the at least one processor of the EGM and the at least one memory device of the EGM both reside within a cabinet of the EGM (as described below). In other embodiments, at least one of the at least one processor of the EGM and the at least one memory device of the EGM reside outside the cabinet of the EGM (as described below).

In certain embodiments, as generally described above, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

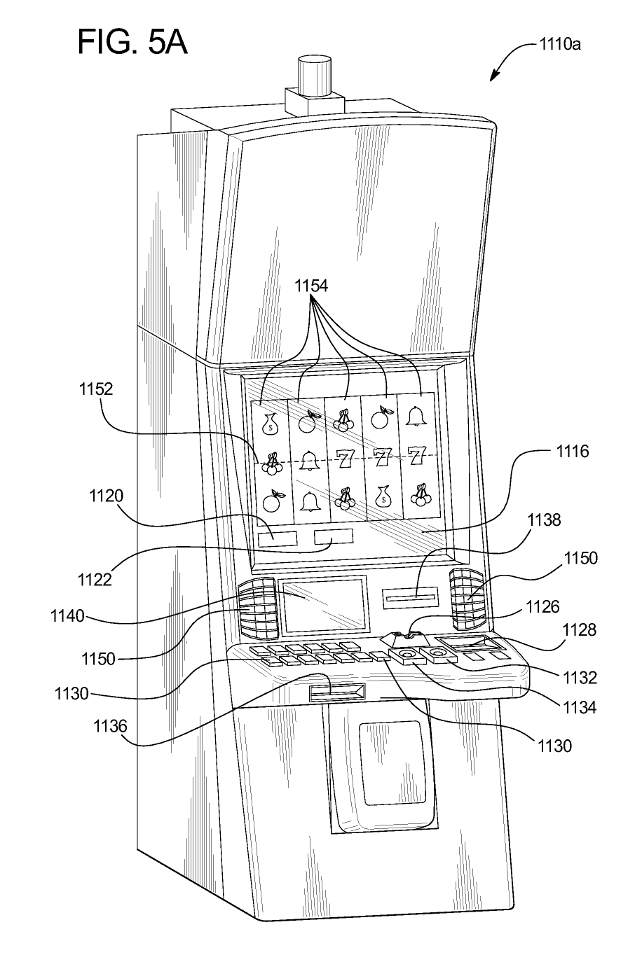

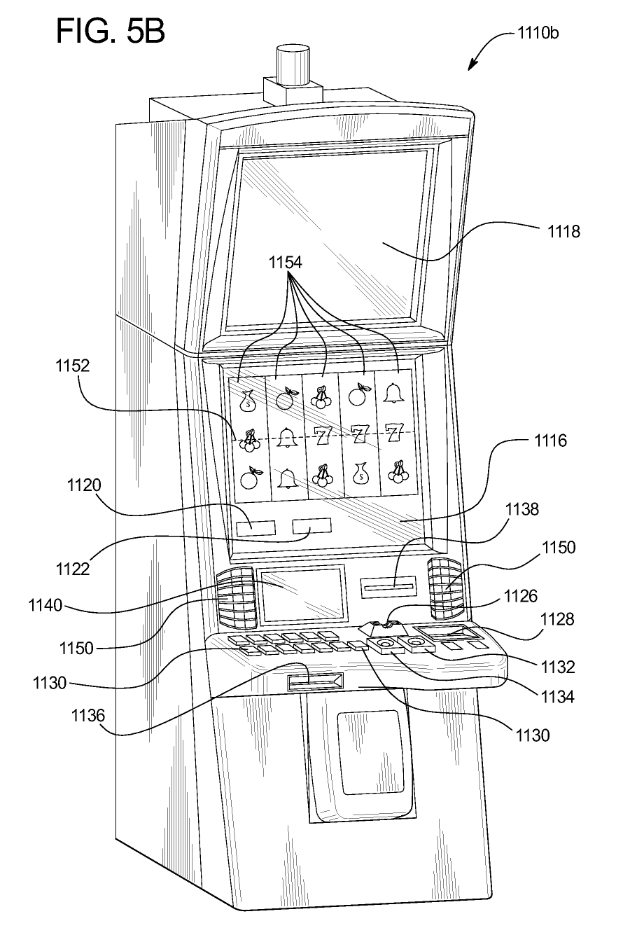

In various embodiments, the EGM includes one or more input devices. The input devices may include any suitable device that enables an input signal to be produced and received by the at least one processor of the EGM. The example EGM illustrated in FIG. 4B includes at least one input device 1030. One input device of the EGM is a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. FIGS. 5A and 5B illustrate example EGMs that each include the following payment devices: (a) a combined bill and ticket acceptor 1128, and (b) a coin slot 1126.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable wired or wireless device, to retrieve relevant information associated with that player to fund the EGM. It should be appreciated that when the EGM is funded, the at least one processor determines the amount of funds entered and displays the corresponding amount on a credit display or any other suitable display as described below.

In various embodiments, one or more input devices of the EGM are one or more game play activation devices that are each used to initiate a play of a game on the EGM or a sequence of events associated with the EGM following appropriate funding of the EGM. The example EGMs illustrated in FIGS. 5A and 5B each include a game play activation device in the form of a game play initiation button 32. It should be appreciated that, in other embodiments, the EGM begins game play automatically upon appropriate funding rather than upon utilization of the game play activation device.

In certain embodiments, one or more input devices of the EGM are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one. It should be appreciated that while the player's credit balance, the player's wager, and any awards are displayed as an amount of monetary credits or currency in the embodiments described herein, one or more of such player's credit balance, such player's wager, and any awards provided to such player may be for non-monetary credits, promotional credits, and/or player tracking points or credits.

In other embodiments, one input device of the EGM is a cash out device. The cash out device is utilized to receive a cash payment or any other suitable form of payment corresponding to a quantity of remaining credits of a credit display (as described below). The example EGMs illustrated in FIGS. 5A and 5B each include a cash out device in the form of a cash out button 1134.

In certain embodiments, one input device of the EGM is a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In various embodiments, one input device of the EGM is a sensor, such as a camera, in communication with the at least one processor of the EGM (and controlled by the at least one processor of the EGM in some embodiments) and configured to acquire an image or a video of a player using the EGM and/or an image or a video of an area surrounding the EGM.

In embodiments including a player tracking system, as further described below, one input device of the EGM is a card reader in communication with the at least one processor of the EGM. The example EGMs illustrated in FIGS. 5A and 5B each include a card reader 1138. The card reader is configured to read a player identification card inserted into the card reader.

In various embodiments, the EGM includes one or more output devices. The example EGM illustrated in FIG. 4B includes at least one output device 1060. One or more output devices of the EGM are one or more display devices configured to display any game(s) displayed by the EGM and any suitable information associated with such game(s). In certain embodiments, the display devices are connected to or mounted on a cabinet of the EGM (as described below). In various embodiments, the display devices serves as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM illustrated in FIG. 5A includes a central display device 1116, a player tracking display 1140, a credit display 1120, and a bet display 1122. The example EGM illustrated in FIG. 5B includes a central display device 1116, an upper display device 1118, a player tracking display 1140, a player tracking display 1140, a credit display 1120, and a bet display 1122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the EGM is a payout device. In these embodiments, when the cash out device is utilized as described above, the payout device causes a payout to be provided to the player. In one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example EGMs illustrated in FIGS. 5A and 5B each include ticket generator 1136. In one embodiment, the EGM includes a payout device configured to fund an electronically recordable identification card or smart card or a bank account via an electronic funds transfer.

In certain embodiments, one output device of the EGM is a sound generating device controlled by one or more sound cards. In one such embodiment, the sound generating device includes one or more speakers or other sound generating hardware and/or software for generating sounds, such as by playing music for any games or by playing music for other modes of the EGM, such as an attract mode. The example EGMs illustrated in FIGS. 5A and 5B each include a plurality of speakers 1150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices. At least U.S. Patent Application Publication No. 2004/0254014 describes a variety of EGMs including one or more communication ports that enable the EGMs to communicate and operate with one or more external peripherals.

As generally described above, in certain embodiments, such as the example EGMs illustrated in FIGS. 5A and 5B, the EGM has a support structure, housing, or cabinet that provides support for a plurality of the input device and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs shown in FIGS. 5A and 5B, EGMs may have varying cabinet and display configurations.

It should be appreciated that, in certain embodiments, the EGM is a device that has obtained approval from a regulatory gaming commission, and in other embodiments, the EGM is a device that has not obtained approval from a regulatory gaming commission.

As explained above, for brevity and clarity, both the EGMs and the personal gaming devices of the present disclosure are collectively referred to herein as “EGMs.” Accordingly, it should be appreciated that certain of the example EGMs described above include certain elements that may not be included in all EGMs. For example, the payment device of a personal gaming device such as a mobile telephone may not include a coin acceptor, while in certain instances the payment device of an EGM located in a gaming establishment may include a coin acceptor.

### Operation of Primary or Base Games and/or Secondary or Bonus Games

In various embodiments, an EGM may be implemented in one of a variety of different configurations. In various embodiments, the EGM may be implemented as one of: (a) a dedicated EGM wherein computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM wherein computerized game programs executable by the EGM for controlling any primary games and/or secondary games displayed by the EGM are downloadable to the EGM through a data network or remote communication link after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. At least U.S. Pat. Nos. 7,470,183; 7,563,163; and 7,833,092 and U.S. Patent Application Publication Nos. 2005/0148382, 2006/0094509, and 2009/0181743 describe various examples of this type of award determination.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos. 7,753,774; 7,731,581; 7,955,170; and 8,070,579 and U.S. Patent Application Publication No. 2011/0028201 describe various examples of this type of award determination.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database for storing player profiles, (b) a player tracking module for tracking players (as described below), and (c) a credit system for providing automated transactions. At least U.S. Pat. No. 6,913,534 and U.S. Patent Application Publication No. 2006/0281561 describe various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGMs shown in FIGS. 5A and 5B each include a payline 1152 and a plurality of reels 1156. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display positions on a requisite number of adjacent reels. In one such embodiment, one or more paylines are formed between at least two symbol display positions that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display positions, the gaming system enables a wager to be placed on a plurality of symbol display positions, which activates those symbol display positions.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display positions on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No. 8,012,011 and U.S. Patent Application Publication Nos. 2008/0108408 and 2008/0132320 describe various examples of ways to win award determinations.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. At least U.S. Pat. Nos. 5,766,079; 7,585,223; 7,651,392; 7,666,093; 7,780,523; and 7,905,778 and U.S. Patent Application Publication Nos. 2008/0020846, 2009/0123364, 2009/0123363, and 2010/0227677 describe various examples of different progressive gaming systems.

As generally noted above, in addition to providing winning credits or other awards for one or more plays of the primary game(s), in various embodiments the gaming system provides credits or other awards for one or more plays of one or more secondary games. The secondary game typically enables a prize or payout in to be obtained addition to any prize or payout obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards. At least U.S. Patent Application Publication Nos. 2007/0123341, 2008/0070680, 2008/0176650, and 2009/0124363 describe various examples of different group gaming systems.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311,605; 7,611,411; 7,617,151; and 8,057,298 describe various examples of player tracking systems.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one display device;
at least one input device;
at least one processor; and
at least one memory device which stores a plurality of instructions, which when executed by the at least one processor if a selection game triggering event occurs, cause the at least one processor to operate with the at least one display device and the at least one input device to:
(a) display a plurality of awards, each award being associated with:
(i) one of a plurality of different award values,
(ii) a designation as one of: available and unavailable, and
(iii) one of a plurality of different unavailability durations,
(b) at periodic intervals, modify the designation of at least one of the displayed awards,
(c) enable a player to pick one of any displayed awards currently designated as available,
(d) provide the award value associated with the picked award,
(e) cause at least one of the displayed awards to be designated as unavailable for the unavailability duration associated with the picked award, and
(f) after an expiration of the unavailability duration associated with the picked award, repeat (c) to (f) until a selection game termination event occurs.

2. The gaming system of claim 1, wherein when executed by the at least one processor, the plurality of instructions cause the at least one processor to cause a plurality of the displayed awards to each be designated as unavailable for the unavailability duration associated with the picked award.

3. The gaming system of claim 1, wherein a first one of the awards is associated with a first award value and a first unavailability duration and a second one of the awards is associated with a second, greater award value and a second, greater unavailability duration.

4. The gaming system of claim 1, wherein the unavailability duration associated with at least one of the displayed awards includes an amount of time.

5. The gaming system of claim 1, wherein when executed by the at least one processor, the plurality of instructions cause the at least one processor to display the plurality of awards moving along a path.

6. The gaming system of claim 5, wherein any awards currently displayed within a designated portion of the path are designated as available and any awards currently displayed outside the designated portion of the path are designated as unavailable.

7. The gaming system of claim 1, wherein when executed by the at least one processor, the plurality of instructions cause the at least one processor to cause each of the displayed awards to be designated as unavailable for the unavailability duration associated with the picked award.

8. The gaming system of claim 1, wherein when executed by the at least one processor, the plurality of instructions cause the at least one processor to delay any periodic modifications of the designation of any displayed awards until the completion of the unavailability duration associated with the picked award.

9. The gaming system of claim 1, wherein at least one of the plurality of different awards values is at least one selected from the group of: a quantity of monetary credits, a quantity of non-monetary credits, a quantity of promotional credits, and a quantity of player tracking points.

10. A gaming system server comprising:
at least one processor; and
at least one memory device which stores a plurality of instructions, which when executed by the at least one processor if a selection game triggering event occurs, cause the at least one processor to:
(a) cause at least one display device to display a plurality of awards, each award being associated with:
(i) one of a plurality of different award values,
(ii) a designation as one of: available and unavailable, and
(iii) one of a plurality of different unavailability durations,
(b) at periodic intervals, modify the designation of at least one of the displayed awards,
(c) enable a player to pick one of any displayed awards currently designated as available,
(d) provide the award value associated with the picked award,
(e) cause at least one of the displayed awards to be designated as unavailable for the unavailability duration associated with the picked award, and
(f) after an expiration of the unavailability duration associated with the picked award, repeat (c) to (f) until a selection game termination event occurs.

11. The gaming system server of claim 10, wherein when executed by the at least one processor, the plurality of instructions cause the at least one processor to cause a plurality of the displayed awards to each be designated as unavailable for the unavailability duration associated with the picked award.

12. The gaming system server of claim 10, wherein a first one of the awards is associated with a first award value and a first unavailability duration and a second one of the awards is associated with a second, greater award value and a second, greater unavailability duration.

13. The gaming system server of claim 10, wherein the unavailability duration associated with at least one of the displayed awards includes an amount of time.

14. The gaming system server of claim 10, wherein when executed by the at least one processor, the plurality of instructions cause the at least one processor to cause the at least one display device to display the plurality of awards moving along a path.

15. The gaming system server of claim 14, wherein any awards currently displayed within a designated portion of the path are designated as available and any awards currently displayed outside the designated portion of the path are designated as unavailable.

16. The gaming system server of claim 1, wherein when executed by the at least one processor, the plurality of instructions cause the at least one processor to cause each of the displayed awards to be designated as unavailable for the unavailability duration associated with the picked award.

17. The gaming system server of claim 10, wherein when executed by the at least one processor, the plurality of instructions cause the at least one processor to delay any periodic modifications of the designation of any displayed awards until the completion of the unavailability duration associated with the picked award.

18. The gaming system server of claim 10, wherein at least one of the plurality of different awards values is at least one selected from the group of: a quantity of monetary credits, a quantity of non-monetary credits, a quantity of promotional credits, and a quantity of player tracking points.

19. The gaming system server of claim 10, which transmits and receives data over a data network.

20. The gaming system server of claim 19, wherein the data network is an internet.

21. A method of operating a gaming system, said method comprising:
(a) causing at least one display device to display a plurality of awards if a selection game triggering event occurs, each award being associated with:
(i) one of a plurality of different award values,
(ii) a designation as one of: available and unavailable, and
(iii) one of a plurality of different unavailability durations,
(b) at periodic intervals, causing at least one processor to execute a plurality of instructions to modify the designation of at least one of the displayed awards,
(c) enabling a player to pick one of any displayed awards currently designated as available,
(d) providing the award value associated with the picked award,
(e) causing the at least one processor to execute the plurality of instructions to cause at least one of displayed awards to be designated as unavailable for the unavailability duration associated with the picked award, and
(f) after an expiration of the unavailability duration associated with the picked award, repeating (c) to (f) until a selection game termination event occurs.

22. The method of claim 21, which includes causing the at least one processor to execute the plurality of instructions to cause a plurality of the displayed awards to each be designated as unavailable for the unavailability duration associated with the picked award.

23. The method of claim 21, wherein a first one of the awards is associated with a first award value and a first unavailability duration and a second one of the awards is associated with a second, greater award value and a second, greater unavailability duration.

24. The method of claim 21, wherein the unavailability duration associated with at least one of the displayed awards includes an amount of time.

25. The method of claim 21, which includes causing the at least one display device to display the plurality of awards moving along a path.

26. The method of claim 25, wherein any awards currently displayed within a designated portion of the path are designated as available and any awards currently displayed outside the designated portion of the path are designated as unavailable.

27. The method of claim 21, which includes causing the at least one processor to execute the plurality of instructions to cause each of the displayed awards to be designated as unavailable for the unavailability duration associated with the picked award.

28. The method of claim 21, which includes causing the at least one delaying any periodic modifications of the designation of any displayed awards until the completion of the unavailability duration associated with the picked award.

29. The method of claim 21, wherein at least one of the plurality of different awards values is at least one selected from the group of: a quantity of monetary credits, a quantity of non-monetary credits, a quantity of promotional credits, and a quantity of player tracking points.

30. The method of claim 21, which is executed through a data network.

31. The method of claim 30, wherein the data network is an internet.
